(19) United States
(12) Patent Application Publication
(10) Pub. No.: US 2013/0096875 A1
(43) Pub. Date: Apr. 18, 2013

(54) LASER-BASED DIMENSIONAL OBJECT MEASUREMENT METHOD AND SYSTEM

(71) Applicant: Brian S. Daniel, Houston, TX (US)

(72) Inventor: Brian S. Daniel, Houston, TX (US)

(21) Appl. No.: 13/556,245

(22) Filed: Jul. 24, 2012

Related U.S. Application Data
(60) Provisional application No. 61/627,789, filed on Oct. 18, 2011.

(51) Int. Cl. G06F 15/00; G01C 3/02

(52) U.S. Cl. 702/159

(57) ABSTRACT

A dimension measuring system includes at least two targets positioned at spaced apart intervals adjacent to an object. A laser-based measuring device is used to measure vectors to the targets and vectors to positions on the object. A processor coupled to the laser-based distance measuring device processes the vectors in order to simultaneously generate dimensions of the object and it's relationship to a baseline reference between the targets. The dimensions and baseline reference can be stored and/or displayed.

Pursuant to 35 U.S.C. §119, the benefit of priority from provisional application 61/627,789, with a filing date of Oct. 18, 2011, is claimed for this non-provisional application.

### FIELD OF THE INVENTION

The invention relates generally to dimension measurement systems and methods, and more particularly to a laser-based method and system for making dimensional measurements of objects.

### BACKGROUND OF THE INVENTION

Measurement of an object's dimensions has typically been accomplished in a manual fashion using fixed-length rulers, adjustable-length rulers (e.g., tape measures), plumb lines, hand levels and combinations thereof. Use of these various manual measurement tools becomes difficult and/or dangerous when object is large and/or irregular in shape, or is located in an environment that is limited in terms of accessibility or is inherently dangerous.

In general, oversized loads must be measured prior to their movement by any land, water, and/or air-based vehicle for reasons of safety, efficiency, etc. Oversized loads transported over land (e.g., by railroad, road travel, etc.) must be measured prior to being moved over a predetermined route in order to assure that the load can travel safely over the route. By way of illustrative example, this scenario will be explained for railway freight. In general, railway freight shipments that exceed a standard geometric envelope are deemed oversized and officially classified as “Dimensional” or “High-Wide-Loads” (HWLs). Each railroad typically has its own set of specifications for what is considered to be a HWL load. When HWLs extend beyond the footprint of a railcar, they are no longer permitted in restricted interchange service. Instead, they must be measured at points of origin and interchange points in route to their destinations to ensure that they can be safely transported across a particular rail line. Typically, several personnel are necessary for measuring a single oversized load.

The current method of measuring HWLs usually requires personnel to either climb onto the load and/or use a ladder to physically measure the high points and wide points of the load. The typical tools used in the current measurement method include a tape measure, plumb line, carpenter's level, and variety of homemade tools to assist inspectors in measuring hard-to-reach high-wide points. Such manual measurements have a number of inherent limitations relative to accuracy, efficiency, and safety.

In terms of accuracy, there are a number of factors that contribute to measurement inaccuracies. For example, many HWLs have critical points that are difficult to reach. As a result, inspectors must often make multiple measurements to determine a single height or width at a critical point on the load. The sum of these manual measurements can be subject to mathematical human error. In addition, field measurements are currently referenced horizontally to the edge of the railcar and vertically to the deck of the railcar (which is referenced vertically to one point on top of a rail). However, clearance calculations must be referenced horizontally to the centerline of the track and vertically to the top of the rail at the centerline (or “top of rail” as it is also known). Horizontal errors arise because a railcar may not always be positioned exactly on the centerline of the track due to wear and tear of suspension components, irregularities in railcar manufacturing, and bolster shifting. Vertical errors arise because the current method assumes that the track is level and fails to account for uneven rail elevations. Further, the current method of measuring HWLs does not account for “humping” or “bellying” (positive or negative camber) of the railcar deck due to the weight of the load and/or the design of the railcar deck. Thus, the current method assumes that the railroad track is level and the deck of the railcar is also level. Since no track or car deck is perfectly level, inaccurate measurement calculations are produced.

In terms of efficiency and safety, most HWLs require two or more people to make the measurements. The current measurement method usually requires personnel to either climb onto the load and/or use a ladder to physically measure the high points and wide points. Often, a man-lift or bucket truck is required to reach critical positions on the load where dimensions are required. Climbing on the loads, positioning/repositioning ladders or bucket trucks are time-consuming tasks. Further, these pre-measuring steps expose personnel to trip/fall hazards on the deck of the railcar, slick surfaces during inclement weather, and overall difficulties in traversing loads due to the generally irregular shapes of HWLs. These combined inefficiencies of the current method also negatively affect overall rail yard operations. During the measurement process, “blue flag” protection is usually required which means the track where the load is being measured is closed. Moreover, if a ladder is used to measure the oversized load, it is often necessary to shut down adjacent tracks in addition to the track where the load is sitting. This negatively affects the railroad's ability to efficiently assemble and switch trains thereby delaying shipments. Additionally, a single measurement error could result in an inefficient routing of the load or a clearance deficiency resulting in a derailment, collision, property damage, environmental damage or even death.

### SUMMARY OF THE INVENTION

Accordingly, it is an object of the present invention to provide a dimension measuring system and method.

Another object of the present invention is to provide a dimension measuring system and method for simply and safely measuring the dimensions of a load in a time efficient manner using a minimum of measurement personnel.

Still another object of the present invention is to provide a dimension measuring system and method for HWLs to be transported by railcar, by truck, by ship, by barge, etc.

Other objects and advantages of the present invention will become more obvious hereinafter in the specification and drawings.

In accordance with the present invention, a dimension measuring system includes at least two targets positioned at spaced apart intervals adjacent to an object and in proximity to either end thereof. A laser-based distance measuring device is positioned within line-of-sight of the targets and the object to be measured. The laser-based measuring device is used to measure vectors to the targets and vectors to positions on the object. A processor coupled to the laser-based distance measuring device processes the vectors to the targets to generate a baseline reference between the targets. The processor also processes the vectors to positions on the object in order to generate dimensions of the object in relation to the baseline reference. A data storage device can be coupled to the processor to store the baseline reference and dimensions of the object. A display can also be provided to display the object's dimensions as well as the dimensions in relation to the baseline reference.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a side schematic view of a dimension measuring system in accordance with an embodiment of the present invention;

FIG. 2 is a view of the dimension measuring system taken along 2-2 in FIG. 1;

FIG. 3 is a part side view, part schematic view of a dimension measuring system in accordance with an embodiment of the present invention for measuring the dimensions of a load that is to be transported on a railcar over a railroad track;

FIG. 4 is an isolated top view of a target positioner in accordance with an embodiment of the present invention;

FIG. 5 is a side view of the target positioner (taken along line 5-5 in FIG. 4) that has been partially cut away to illustrate an exemplary self-centering/aligning spring mechanism; and

FIG. 6 is a side view of the target positioner taken line 6-6 in FIG. 4.

### DETAILED DESCRIPTION OF THE INVENTION

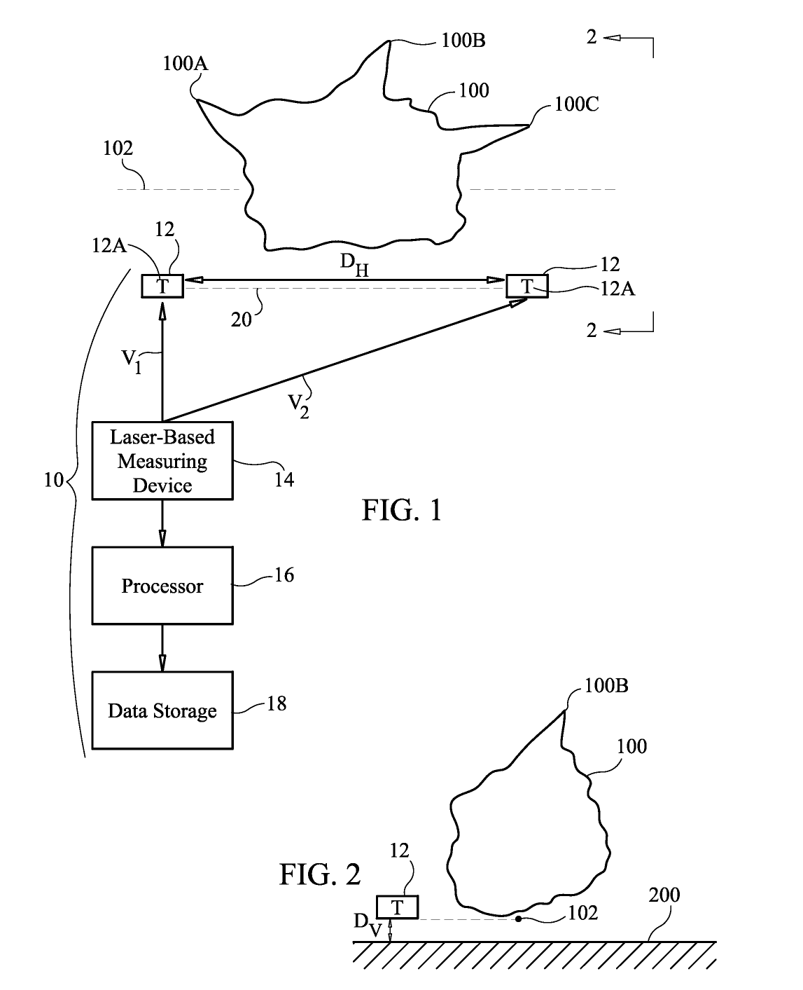

Referring now to the drawings, simultaneous reference will made to FIGS. 1 and 2 where a dimension measuring system in accordance with an embodiment of the present invention is illustrated and is referenced generally by numeral 10. System 10 will be explained for its use in measuring the dimensions of an object 100, the size and shape of which are not limitations of the present invention. Indeed, one of the great advantages of system 10 is its ability to be used to measure dimensions associated with an object 100 of any size or shape positioned on any ground surface, platform, etc., while simultaneously determining/presenting the dimensions in relation to a baseline reference such as the surface, the platform, some industry standard reference, etc.

System 10 includes at least two targets (“T”) 12 positioned at or near opposing ends of object 100 with targets 12 being located at fixed locations whose relationships relative to a reference 102 (e.g., line, plane, railroad track, etc.) are known. Targets 12 can be adjacent to object 100 where “adjacent to” includes targets 12 being next to or on object 100. Each of targets 12 includes a surface region 12A (e.g., planar surface(s), convexly curved surface(s), concavely curved surface(s), etc.) that is (along with object 100) in line-of-sight a laser-based distance measuring device 14. Laser-based distance measuring device 14 can be a reflectorless laser-based device (e.g., electronic distance measuring instrument employing a “time of flight” measurement using a pulsed laser or a phase shift measurement scheme using a continuous “carrier wave” laser modulated with a measuring signal, scanning laser, etc.). Such instruments are known in the art and are commercially available. Coupled to device 14 is a processor 16 that, in turn, can be coupled to an onboard or remotely located data storage device 18. Device 14, processor 16, and data storage device 18 can be individual components or can be integrated into a single system without departing from the scope of the present invention.

Regardless of the type of laser-based measuring device 14 used, the basic dimension measurement approach using system 10 begins by measuring vectors (using device 14) to each of targets 12 once device 14 is positioned at a location that is within line-of-sight of both targets 12 and object 100. The two measured vectors V₁ and V₂ (i.e., a distance defined by horizontal and vertical components or distances and angles with respect to a datum such as a ground or selected horizontal) are provided to processor 16 so that a baseline reference 20 defined between targets 12 can be generated. Baseline reference 20 will have a horizontal component D_{H} (i.e., distance between targets 12) as illustrated in FIG. 1, and will have a vertical component D_{V} (i.e., the height of baseline reference 20 relative to a fixed datum that can be a ground surface 200 or some other feature that is fixed such as the vertical alignment of a railroad track) as illustrated in FIG. 2.

Once baseline reference 20 is established, device 14 is used to measure a number of vectors to positions on object 100 needed to establish its relevant dimensions for a particular application. For example, if it is critical to know the envelope occupied by object 100, device 14 might be used to measure vectors to various “extremities” (e.g., 100A-100C) on object 100. Vectors to these extremities are referenced to baseline reference 20 at processor 16 in order to generate dimensions of object 100. Such processing involves use of standard geometric relationships as would be understood in the art. Data defining baseline reference 20 and dimensions of object 100 (i.e., both raw dimension measurements and dimensions in relation to baseline reference 20) can be stored in data storage device 18.

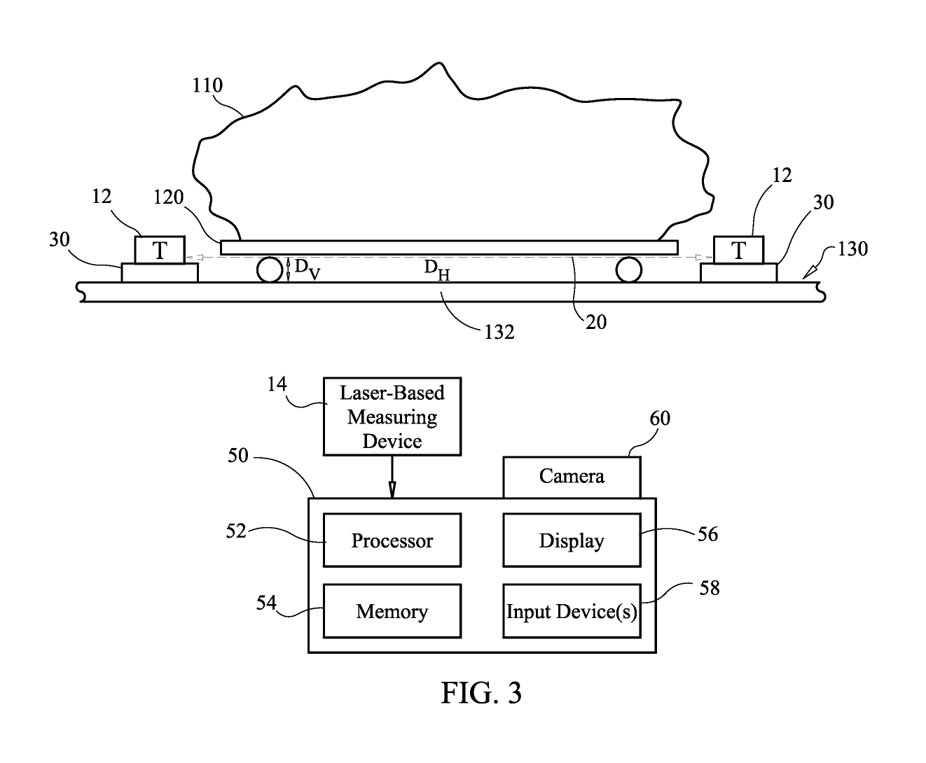

While the above-described dimension measuring system 10 can be used in a variety of applications, the present invention is particularly useful for the dimension measurement of “High-Wide Loads” (HWLs) to be transported on railcars over railroad tracks. Accordingly, an embodiment of the present invention well-suited for this application will now be described with simultaneous reference to FIGS. 3-6.

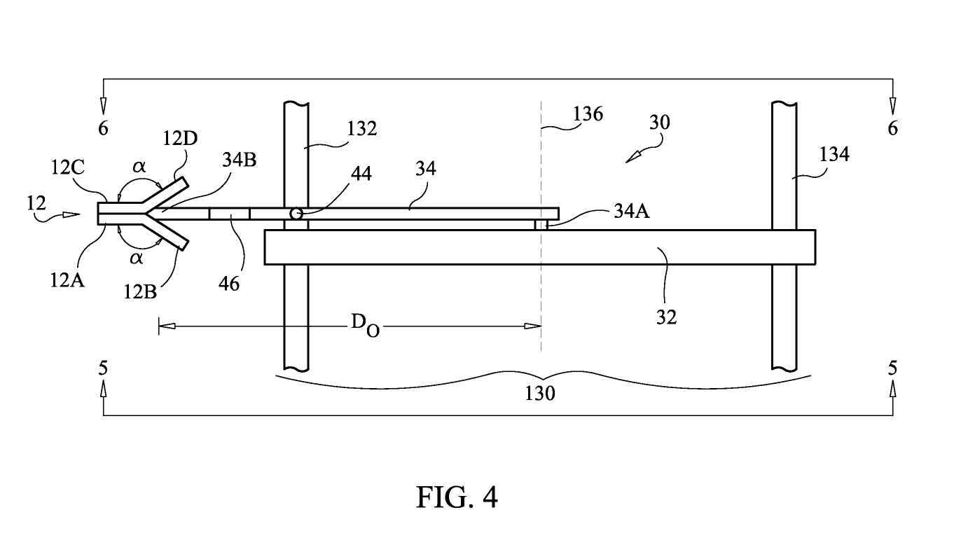

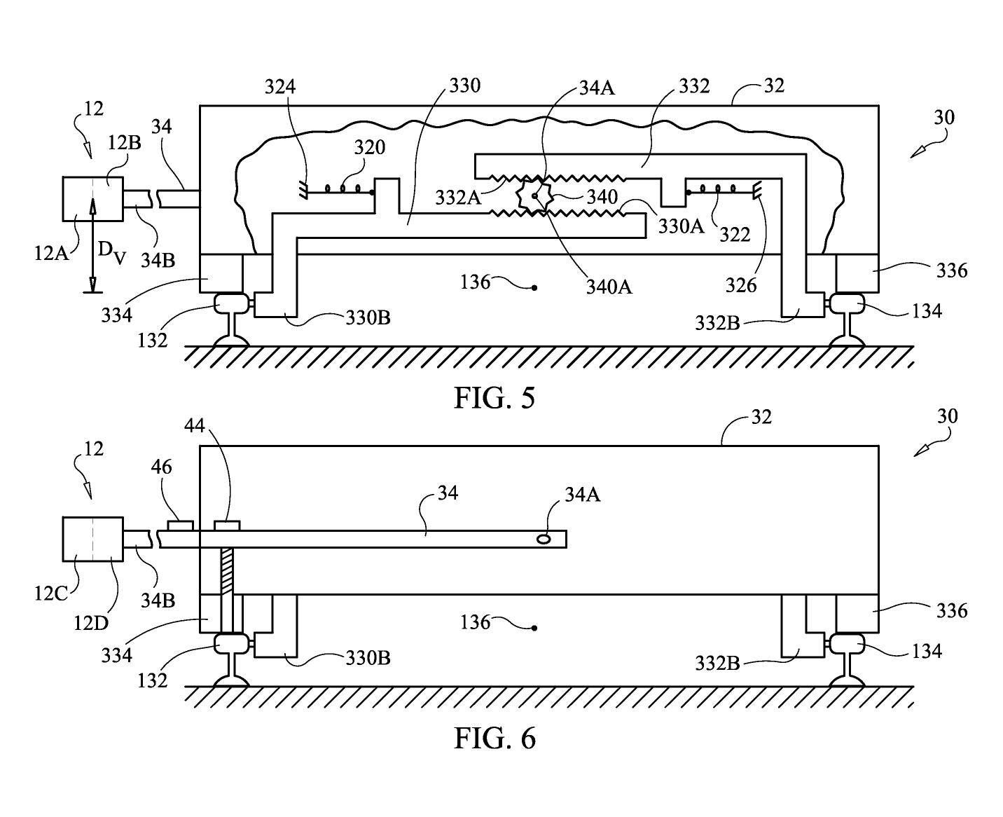

Referring first to FIG. 3, a HWL 110 is loaded on the bed of a railcar 120 positioned on the rails 132/134 (only rail 132 is visible in FIG. 3) of a railroad track 130. Two targets 12 are positioned near opposing ends of railcar 120. Each of targets 12 is supported on a support/positioning mechanism 30 fixed to railroad track 130 during the dimension measuring process of the present invention. In general, support/positioning mechanism 30 positions its target 12 at a fixed horizontal offset distance D_{O} (visible in FIGS. 3 and 4) from a centerline 136 of railroad track 130, and a fixed vertical distance D_{V} (visible in FIGS. 3 and 5) above the top of rails 132/134 at the centerline of railroad track 130. Note that fixed vertical distance D_{V} could be referenced to the absolute top of the rail or at some fixed distance below the top of the rail (e.g., 0.625 inches depending on industry standards) without departing from the scope of the present invention. In the illustrated example, the central portion of each target 12 is used as point of measurement for horizontal distance D_{H} and vertical distance D_{V}, although other points on target 12 could be used without departing from the scope of the present invention. If horizontal distance D_{H} and vertical distance D_{V} are the same for each of targets 12, then targets 12 will define a baseline reference 20 that is referenced to railroad track 130, i.e., parallel to centerline 136 at a known/fixed distance above the top of rails 132/134 of railroad track 130.

An embodiment of support/positioning mechanism 30 that can be used in the establishment of baseline reference 20 will now be described with reference to FIGS. 4-6. Each support/positioning mechanism 30 has two rigid bars 32 and 34. In general, bar 32 is configured to engage rails 132/134 of railroad track 130 and rest on top thereof. Bar 34 is pivotally coupled near one end thereof at 34A to bar 32 and supports target 12 at its outboard end 34B at a location outside of (i.e., beyond the confines of) railroad track 130. More specifically, mechanism 30 is configured such that pivot coupling 34A is aligned with centerline 136 of railroad track 130 and such that bar 34 is placed in a level horizontal orientation. In this way, each target 12 positioned by one of support/positioning mechanisms 30 is positioned to define a baseline reference that is parallel to centerline 136 at a fixed/known vertical distance above the average top of rails 132/134. However, it is to be understood that the baseline reference could be otherwise located relative to railroad track 130 without departing from the scope of the present invention.

Bar 32 is configured for secure engagement of rails 132/134 while automatically aligning pivot coupling 34A with centerline 136. An embodiment that achieves this is illustrated in FIG. 5 where an internal region of bar 32 is exposed to illustrate an embodiment of a self-centering/aligning mechanism. It is to be understood that other self-centering/aligning mechanisms could be used without departing from the scope of the present invention. In the illustrated example, each of identical springs 320 and 322 has one outboard end fixed at 324 and 326, respectively, in/on bar 32. The opposing end of each spring 320/322 is fixed to a movable shoe/rack gear 330/332. Rack gear teeth 330A/332A engage the teeth of a rotatable pinion gear 340 whose axis of rotation 340A is aligned with pivot coupling 34A. Each shoe/rack gear 330/332 has a shoe 330B/332B protruding from bar 32. When positioning bar 32 to engage rails 132/134, shoes 330B and 332B are moved towards one another (i.e., springs 320/322 are stretched) to fit within the confines of rails 132/134. Springs 320/322 are then allowed to relax/compress whereby shoes 330B/332B engage the inside of rails 132/134 to thereby fix axis or rotation 340A and pivot coupling 34A at centerline 136 at a fixed height above the average top of rails 132/134. Bar 32 can include feet 334/336 for resting on the top of rails 132/134.

Once bar 32 is positioned as described, bar 34 is pivoted about pivot coupling 34A until it achieves a level horizontal orientation. An embodiment for achieving this is shown and is best seen FIGS. 4 and 6. A leveling screw 44 can pass through bar 34 for engagement with the top of one of the rails (e.g., rail 134 in the figures). Turning of screw 44 rotates bar 34 up/down relative to pivot coupling 34A. A bubble level 46 can be attached to or incorporated in bar 34 to facilitate the leveling of bar 34.

As mentioned above, a target 12 is coupled to the outboard end 34B of bar 34. Target 12 can be a variety of shapes, sizes, surface finishes, etc., without departing from the scope of the present invention. Since target 12 will typically be “targeted” by a laser-based measuring device located on the order of tens to a few hundred feet away from the targets, target 12 is ideally one that is not easily missed by a laser-based measuring device regardless of the angle of incidence. The illustrated embodiment of target 12 is constructed from multiple intersecting planar surface regions 12A-12D. Regions 12A and 12B provide a target “face” from one direction while regions 12C and 12D provide a target “face” from an opposing direction. To accommodate a wide range angles of incidence, each of regions 12A/12B and 12C/12D define an angle α (FIG. 4) therebetween in the range of approximately 110°-130°. The line of intersection of the surface regions defines the aim point for the laser-based distance measuring device used to measure the distance/angles to the target.

Referring again to FIG. 3, laser-based measuring device 14 is first used to measure vectors between device 14 and each of targets 12. These vectors are provided to a data logger 50 that includes an onboard processor 52, memory 54, display 56, and input device(s) 58 (e.g., keypad, touch screen, voice recognition, etc.) used to control operation of data logger 50. Data logger 50 can also include or be coupled to a digital camera 60. For clarity of illustration, data lines coupling the elements of data logger 50 have been omitted.

Measurements can be provided by device 14 to data logger 50 over hardwire connections or wireless connections (e.g., Bluetooth) without departing from the scope of the present invention. As described above, the distance/angles (i.e., vectors) to each of targets 12 are used by processor 52 to generate baseline reference 20 between targets 12 that is parallel to centerline 136 but a fixed vertical distance D_{V} above the average top of rails 132/134. Without moving device 14, vectors are then measured by device 14 to a variety of points on load 110. These vectors to various points on load 110 are readily used to determine absolute dimensions of load 100 and are readily referenced to baseline reference 20. The vectors used to establish baseline reference 20 and the vectors to points on load 110 can be stored in memory 54 and/or displayed on display 56 either automatically or on demand. Similarly, the dimensions of load 110 generated by processor 52 can be stored/displayed automatically and/or on demand. When camera 60 is provided, digital photos of load 110 can be taken/captured for storage/display automatically and/or on demand. Displayed images of load 110 could also include calculated dimensions thereof superimposed on the displayed image. Additional shipping, commodity, and/or administrative information can be input, stored, and/or displayed using data logger 50 without departing from the scope of the present invention.

The format used for data storage and/or display can be tailored for a specific application. For example, in terms of measuring loads to be transported over railroad tracks in the U.S., minimum load measurement requirements are dictated by the Association of American Railroads' Open Top Loading Rules.

The advantages of the present invention are numerous. Object/load measurement can be accomplished accurately, safely and efficiently by one person. Only two targets need be placed near an object and then most or all measurements can be taken from a single location. If additional measurement locations are needed, the targets are again measured from the new location to establish a new baseline reference for subsequent object/load measurements. Raw measurements and object/load dimension and relational data can be stored for processing and/or archival purposes. The present invention's target support/positioning mechanisms readily position targets at fixed locations offset from the object/load to provide for a simple and accurate establishment of a baseline reference that support all measurement-to-dimension processing.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A dimension measuring system, comprising:
at least two targets adapted to be positioned at spaced apart intervals adjacent to an object and in proximity to either end thereof;
a laser-based distance measuring device adapted to be positioned within line-of-sight of said targets and the object for measuring vectors to said targets and for measuring vectors to positions on the object; and
a processor coupled to said laser-based distance measuring device for processing said vectors to said targets to generate a baseline reference defined between said targets and for processing said vectors to positions on the object to generate dimensions of the object in relation to said baseline reference.

2. A dimension measuring system as in claim 1, further comprising a data storage device coupled to said processor for storing said baseline reference and said dimensions.

3. A dimension measuring system as in claim 1, wherein each of said targets includes at least one surface region in said line-of-sight.

4. A dimension measuring system as in claim 1, wherein each of said targets is defined by at least two intersecting planar surfaces.

5. A dimension measuring system as in claim 1, further comprising a support mechanism for each of said targets, each said support mechanism comprising:
a first bar adapted to be fixed to a ground location in proximity to an end of the object; and
a second bar pivotally coupled to said first bar at one end thereof, said second bar having a second end rotatable about said first end, wherein one of said targets is coupled to said second end.

6. A dimension measuring system as in claim 5, further comprising a leveling mechanism coupled to said second bar and operable to place said second bar in a level horizontal orientation.

7. A dimension measuring system as in claim 5, further comprising a bubble level coupled to said second bar.

8. A dimension measuring system as in claim 1, further comprising a digital camera coupled to said data storage device.

9. A dimension measuring system as in claim 1, further comprising a display coupled to said processor and said data storage device for displaying at least one of said vectors to each of said targets, said vectors to positions on the object, and said dimensions of the object in relation to said baseline reference.

10. A dimension measuring system for measuring a load that is to be transported by railcar on a railroad track, comprising:
a reflectorless laser-based distance measuring instrument;
a plurality of target positioners, each of said target positioners including a target, each of said target positioners adapted to be fixed to a railroad track and position said target associated therewith at a fixed horizontal distance from a centerline of the railroad track and a fixed vertical distance above the railroad track;
said measuring instrument adapted to be positioned within line-of-sight of said targets and a load located approximately between two of said target positioners, said measuring instrument operable to measure vectors to said targets and vectors to positions on the load; and
a processor coupled to said measuring instrument for processing said vectors to said targets to generate a baseline reference defined between two of said targets and for processing said vectors to positions on the load to generate dimensions of the load in relation to said baseline reference.

11. A dimension measuring system as in claim 10, further comprising a data storage device coupled to said processor for storing said baseline reference and said dimensions.

12. A dimension measuring system as in claim 10, wherein each of said targets is defined by at least two intersecting planar surfaces.

13. A dimension measuring system as in claim 10, wherein each of said target positioners comprises:
a first bar that is rigid;
a positioning mechanism coupled to said first bar and adapted to engage the railroad track's rails wherein said first bar is coupled to the railroad track's rails, and wherein a position on said first bar is aligned with a centerline of the railroad track;
a second bar that is rigid, said second bar pivotally coupled to said first bar at said position thereon aligned with the centerline of the railroad track, said second bar having a free end adapted to be positioned outside of the railroad track when said second bar is approximately parallel to said first bar; and
said target coupled to said free end of said second bar.

14. A dimension measuring system as in claim 13, wherein said positioning mechanism includes:
a first stop adapted to engage an inside portion of one of the railroad track's rails;
a second stop adapted to engage an inside portion of an opposing one the railroad track's rails; and
a spring mechanism centered at said position aligned with the centerline of the railroad track and coupled to said first stop and said second stop for spring biasing said first stop and said second stop away from one another.

15. A dimension measuring system as in claim 13, further comprising a leveling mechanism coupled to said second bar and operable to place said second bar in a level horizontal orientation.

16. A dimension measuring system as in claim 13, further comprising a bubble level coupled to said second bar.

17. A dimension measuring system as in claim 10, further comprising a digital camera coupled to said data storage device.

18. A dimension measuring system as in claim 10, further comprising a display coupled to said processor and said data storage device for displaying at least one of said vectors to each of said targets, said vectors to positions on the load, and said dimensions of the load.

19. A dimension measuring system, comprising:
a reflectorless laser-based distance measuring instrument;
two targets adapted to be positioned in a spaced apart relation adjacent to an object and in proximity to either end thereof;
said measuring instrument adapted to be positioned within line-of-sight of said targets and an object located approximately between said targets, said measuring instrument operable to measure vectors to said targets and vectors to positions on the object;
a processor coupled to said measuring instrument for processing said vectors to said targets to generate a baseline reference defined between said targets and for processing said vectors to positions on the object to generate dimensions of the object in relation to said baseline reference;
a data storage device coupled to said processor for storing baseline reference and said dimensions;
a digital camera operable to capture images of the object, said digital camera coupled to said data storage device wherein said images are stored on said data storage device; and
a display coupled to said processor and said data storage device for displaying at least one of said vectors to each of said targets, said vectors to positions on the object, said dimensions of the object in relation to said baseline reference, and said images of the object.

20. A dimension measuring system as in claim 19, wherein each of said targets includes at least one surface region in said line-of-sight.

21. A dimension measuring system as in claim 19, wherein each of said targets is defined by at least two intersecting planar surfaces.

22. A dimension measuring system as in claim 19, further comprising a support mechanism for each of said targets, each said support mechanism comprising:
a first bar adapted to be fixed to a ground location in proximity to an end of the object; and
a second bar pivotally coupled to said first bar at one end thereof, said second bar having a second end rotatable about said first end, wherein one of said targets is coupled to said second end.

23. A dimension measuring system as in claim 22, further comprising a leveling mechanism coupled to said second bar and operable to place said second bar in a level horizontal orientation.

24. A dimension measuring system as in claim 22, further comprising a bubble level coupled to said second bar.
